(19) United States
(12) Patent Application Publication
(10) Pub. No.: US 2016/0285699 A1
(43) Pub. Date: Sep. 29, 2016

(54) COMMUNICATION NETWORK AND COMMUNICATION NODE OF A COMMUNICATION NETWORK

(71) Applicant: AIRBUS OPERATIONS (S.A.S.), TOULOUSE Cedex 9 (FR)

(72) Inventors: Juan LOPEZ, Grenade (FR); Benoit BERTHE, TOULOUSE (FR); Valentin KRETZSCHMAR, Toulouse (FR)

(21) Appl. No.: 15/077,142

(22) Filed: Mar. 22, 2016

(30) Foreign Application Priority Data
Mar. 26, 2015 (FR) 15 52568

(51) Int. Cl. H04L 12/24; H04L 12/26; H04L 12/721; H04L 12/873; H04L 5/14; H04L 12/703

(52) U.S. Cl. CPC H04L 41/145; H04L 5/14; H04L 45/28; H04L 45/66; H04L 47/521; H04L 43/16; H04L 2012/4028

(57) ABSTRACT

The communication network includes a set of links each supporting a specified bandwidth, a set of subscribers and at least one communication node comprising a set of communication ports configured for being connected to links of the network. Each of the subscribers is associated with an authorized maximum bandwidth for transmission on the network, the total of authorized maximum bandwidths corresponding to respective subscriber being less than or equal to the authorized maximum bandwidth associated with respective subscriber. The communication node includes a processing unit configured for, when a data frame is received on one of the communication ports: checking if a memory contains an identifier associated with that data frame; and if the memory does not contain the identifier associated with that data frame: sending that data frame to all of the other communication ports of the communication node and storing the identifier associated with the data frame in the memory.

### RELATED APPLICATION

The present application claims priority to French Patent Application Number 15 52568, filed Mar. 26, 2015, the disclosure of which is entirely incorporated by reference.

### TECHNICAL FIELD

The technology herein relates to the field of communication networks and more particularly to communication networks installed in aircraft.

### BACKGROUND

Aircraft generally comprise one or more onboard communication networks provided to allow communications between onboard equipment, for example onboard computers. In order to meet the regulatory requirements regarding certification of aircraft, an onboard communication network must allow a deterministic transmission of data between the different equipment subscribed to this communication network. The ARINC 664 part 7 standard defines a deterministic onboard avionic communication network, based on a full-duplex Ethernet technology. Such a network can for example correspond to an AFDX® communication network. In a network conforming with the ARINC 664 part 7 standard, each item of equipment is connected to a switch of the network and the communications between the different equipment use virtual links predefined during the design of the network. A virtual link is defined between an item of transmitting equipment and one or more items of receiving equipment, via one or more switches of the network. Each virtual link uses a determined path in the network. A bandwidth is allocated to each virtual link and the routing of the different virtual links of the network is carried out in such a way that the total of the bandwidths allocated to the virtual links using a same physical link does not exceed the bandwidth supported by said physical link. This makes it possible to guarantee the determinism of the network. However, a few constraints result from this, in particular with regard to the configuration management of the network. All of the communications between equipment must be defined in advance, by the definition of the virtual links, in order to allow a configuration of the switches. All communications between the equipment therefore must be defined very early in the process of development of the systems installed in the aircraft. As a result, the configuration of the switches of the network and the configuration of each switch must be downloaded into respective switch before it is used. This configuration must be consistent with the subscribed equipment actually connected to the network. Moreover, when a physical link or a switch of the network is unavailable, the different virtual links passing through that physical link or that switch are unavailable.

### SUMMARY OF THE INVENTION

The technology herein seeks to provide a solution to the above-identified problems. It relates to a communication network comprising:

a set of links each supporting a specified bandwidth;

a set of subscribers; and

at least one communication node comprising a set of communication ports, these communication ports being connected to links of the set of links.

This network is noteworthy in that:

each one of the set of subscribers is associated with an authorized maximum bandwidth for transmission on the network, in such a way that the total of the authorized maximum bandwidths corresponding to respective subscriber is less than or equal to said authorized maximum bandwidth associated with respective subscriber,

said at least one communication node comprises a processing unit and a memory and the processing unit is configured for, when a data frame is received on one of the communication ports of the communication node:

checking if the memory contains an identifier associated with that data frame; and

if the memory does not contain an identifier associated with that data frame:

sending that data frame to all of the other communication ports of the communication node; and

storing the identifier of the data frame in the memory.

Thus, said at least one communication node distributes the received data frame to all of the other ports. This makes it possible to distribute the frame to all of the destination subscribers, without a configuration of the communication node or nodes of the network. Moreover, by virtue of the identifier associated with a data frame, if the communication node in question receives a data frame several times because of the distribution of said data frame in the network by several communication nodes, the communication node does not retransmit the data frame. This makes it possible to avoid saturation of the communication network by guaranteeing that a same data frame, to which a specified identifier corresponds, can only be transmitted once by a communication port of a communication node. Moreover, given that the total of the authorized maximum bandwidths associated with each of the subscribers is less than or equal to the specified bandwidth supported by each of the links, the data traffic corresponding to data frames transmitted by the different subscribers does not risk saturating the communication network. The communication network therefore makes it possible to route a data frame transmitted by a subscriber, to the destination subscriber (or subscribers), without risking saturation of the network. Moreover, this network does not necessitate a configuration of virtual links in communication nodes of the network, which makes it possible to facilitate modifications of the subscribers of the network. For example, it is possible to modify easily the list of the destination subscribers of a data frame transmitted by a subscriber: such a modification only necessitates a parameterization of the transmitting subscriber and/or of the destination subscriber or subscribers.

Advantageously, the links of the set of links are arranged in pairs in order to form a network of the full-duplex type.

According to one example embodiment, the subscribers of the set of subscribers are configured for communicating on the network according to a communication protocol compatible with the ARINC 664 part 7 standard. Advantageously, the identifier associated with a data frame corresponds to a virtual link identifier and a sequence number of the frame.

According to another example embodiment, the set of subscribers are configured for communicating on the network according to a communication protocol compatible with the Ethernet standard. Advantageously, the identifier associated with a data frame corresponds to an identifier of the transmitting subscriber and a frame number generated by that subscriber.

In a particular example embodiment, the communication network comprises at least four communication nodes, each communication node comprising four communication ports, these communication nodes being arranged according to a matrix topology.

Advantageously, said at least one communication node is integrated in one of the set of subscribers. This makes it possible to simplify the communication network, as the communication network does not need specific equipment for implementing the functions of a communication node. The communication network thus comprises only subscribers and a set of links between these subscribers.

The technology herein also relates to a communication node of a communication network, this network comprising a set of links each supporting a specified bandwidth, the network further comprising a set of subscribers, with each of which is associated an authorized maximum bandwidth for transmission on the network, in such a way that the total of authorized maximum bandwidths corresponding to respective subscriber is less than or equal to the authorized maximum bandwidth associated with respective subscriber, the communication node comprising a set of communication ports, these communication ports being provided for being connected to links of the network.

The communication node comprises a processing unit and a memory and the processing unit is configured for, when receiving a data frame on one of the communication ports of the communication node:

checking if the memory contains an identifier associated with that data frame;

if the memory does not contain an identifier associated with that data frame:

sending that data frame to all of the other communication ports of the communication node; and

storing, in the memory, the identifier associated with the data frame.

Advantageously, the communication node comprises a transmission queue associated with a communication port. Such a queue makes it possible to store data frames received by the communication node, before they are retransmitted, in order to avoid data collisions on the communication links.

The communication node further comprises:

a reception queue associated with a communication port; and

a traffic regulator configured for reading data in the reception queue and for sending these data to the processing unit, whilst limiting the reading and sending of the data in terms of an authorized maximum bandwidth for that communication port.

When this communication port is connected to a subscriber, this makes it possible to limit the data traffic coming from the subscriber and retransmitted by the communication node on the network, in order to protect against saturation of the communication network. The authorized maximum bandwidth for this communication port is then advantageously chosen to be equal to the authorized maximum bandwidth for transmission on the network associated with that subscriber.

The technology herein also relates to an aircraft comprising a communication network such as mentioned above.

### BRIEF DESCRIPTION OF THE DRAWINGS

These and further aspects of the exemplary implementations will be better understood on reading the following description and on examination of the appended figures.

FIG. 1 is a simplified illustration of an example aircraft comprising a communication network.

FIG. 2 shows a communication network according to one non-limiting exemplary embodiment of the invention.

FIGS. 3, 4 and 5 illustrate non-limiting exemplary communication nodes of a communication network.

FIG. 6 illustrates a non-limiting exemplary subscriber of a communication network integrating a communication node.

FIG. 7 shows a non-limiting exemplary communication network comprising subscribers such as the one shown in FIG. 6.

### DETAILED DESCRIPTION

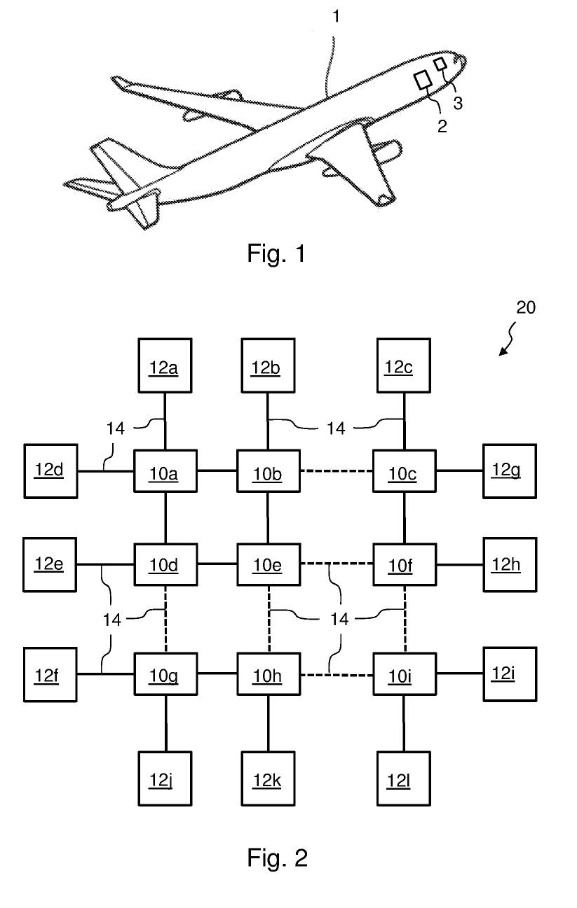

The communication network 20 shown in FIG. 2 comprises a set of subscribers 12a, 12b, . . . 12k, 12l, a set of communication nodes 10a, 10b, . . . 10i and a set of communication links 14. In an example embodiment, the communication network can correspond to a communication network of an aircraft 1, comprising a cockpit 3, as shown in FIG. 1. In the example embodiment, subscribers of the set of subscribers may correspond to computers of the aircraft, for example avionic computers. These computers, as well as the communication nodes and the communication links can be situated in an avionics bay 2 of the aircraft.

Each subscriber comprises a communication port connected, by a communication link 14, to a communication port of one of the communication nodes. Each communication node comprises several communication ports, for example 4 communication ports as shown in FIG. 2. Communication ports not connected to a subscriber are connected to ports of other communication nodes by other links 14. The different communication ports are transmitting and receiving ports and the links 14 are arranged in pairs in order to form a full-duplex communication network. Each link 14 supports a specified bandwidth, for example 100 Mbits/s. Moreover, each one of the set of subscribers is associated with an authorized maximum bandwidth for transmission on the network, such that the total of the authorized maximum bandwidths corresponding to respective subscribers is less than or equal to the authorized maximum bandwidth associated with respective subscriber. In particular, the bandwidth can be distributed in a similar manner among the different subscribers. Thus, an authorized maximum bandwidth of 8.33 Mbits/s can be associated with each of the 12 subscribers 12a, 12b, . . . 12l. The total of the authorized maximum bandwidths associated with each of the subscribers is then equal to the specified bandwidth, for example 100 Mbits/s. Alternatively, different authorized maximum bandwidths can be associated with different subscribers. For example, the 4 subscribers 12a, 12b, 12c and 12d can each have an authorized maximum bandwidth of 10 Mbits/s, the other 8 subscribers each having an authorized maximum bandwidth of 7.5 Mbits/s. The total of the authorized maximum bandwidths associated with each of the subscribers is then equal to the specified bandwidth, for example 100 Mbits/s. Such a configuration of the authorized maximum bandwidths for each of the subscribers makes it possible to guarantee that, even if all of the subscribers are simultaneously transmitting data on the communication network, all of the data likely to pass through a link does not exceed the bandwidth supported by that link.

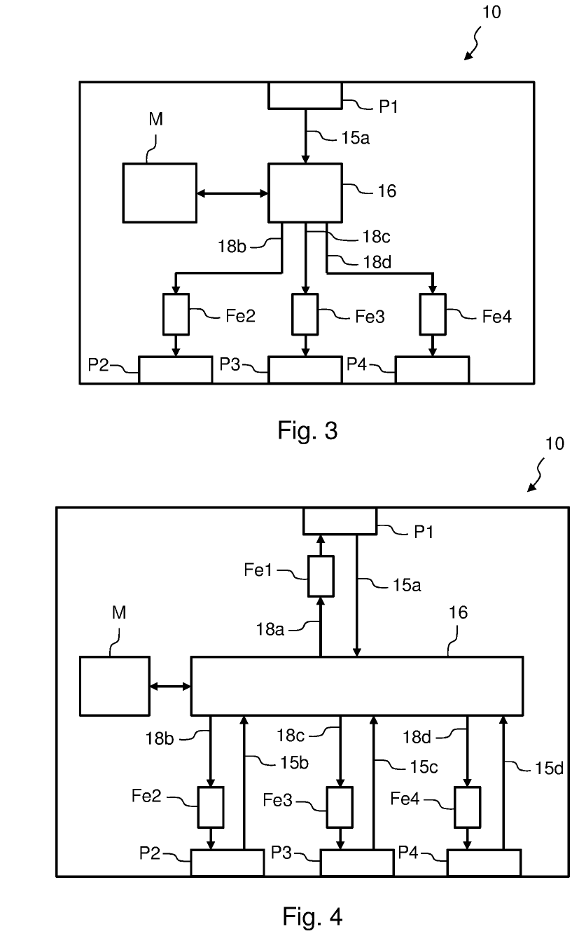

As shown in FIGS. 3 and 4, a non-limiting exemplary communication node 10 of a communication network comprises, for example, four communication ports P1, P2, P3 and P4. FIG. 3 corresponds to a simplified representation of the communication node allowing a better understanding of its operation during the reception of data on the communication port P1: only the elements of the communication node used during said reception are shown. The communication node 10 comprises a processing unit 16, for example a processor, connected to a memory M. It also comprises transmission queues Fe1, Fe2, Fe3 and Fe4 respectively associated with the communication ports P1, P2, P3 and P4. These transmission queues are connected to the processing unit 16 respectively by links 18a, 18b, 18c and 18d respectively. The communication node also comprises links 15a, 15b, 15c and 15d respectively from the communication ports P1, P2, P3 and P4 to the processing unit 16, allowing the transmission to the processing unit of data received by the communication ports.

During operation, the data flowing on the different links 14 of the communication network 20 correspond to data frames. A data frame is transmitted, by a subscriber of the network, to one or to several other subscribers of the network. When a communication node 10 receives a data frame on a communication port, for example the port P1, this port transmits the data corresponding to the received data frame to the processing unit 16 by means of the link 15a. The processing unit analyzes the data received and retrieves an identifier associated with the data frame. The processing unit then checks if this identifier is already recorded in the memory M. If the memory does not contain this identifier, then the processing unit sends the data corresponding to the received data frame to the queues Fe2, Fe3 and Fe4 associated with the other communication ports P2, P3 and P4, respectively by the links 18b, 18c and 18d. The data frame is then retransmitted by each of the other communication ports P2, P3 and P4. Moreover, the processing unit 16 records, in the memory M, the identifier associated with the data frame. Thus, the communication node 10 retransmits the received data frame only if the identifier associated with that data frame was not already stored in its memory M, namely, if the data frame had not yet been received by that communication node. On the other hand, if the data frame has already been received by the communication node, then its identifier is already recorded in the memory M and consequently the processing unit 16 does not send the data corresponding to this data frame to the transmission queues Fe2, Fe3 and Fe4. Thus, the data frame is not retransmitted by communication ports P1, P2 or P3. This makes it possible to avoid sending a same data frame several times on a same link of the communication network, which prevents the saturation of the bandwidth supported by said link. The use of a transmission queue associated with each communication port makes it possible to avoid data collisions during transmission, for example, when the communication node receives data frames simultaneously on several communication ports, the data corresponding to these data frames are sent to the transmission queues by the processing unit 16. The data is then transmitted by the corresponding communication ports according to a FIFO (First In, First Out) principle.

Each communication node of the communication network retransmits the data frames received, by each of the communication ports of said node, on all of its other communication ports. This makes it possible to distribute, in the communication network, a data frame transmitted by a subscriber. In particular, in the case of a non-limiting exemplary communication network 20, such as the one shown in FIG. 2, of which communication nodes 10a, 10b, . . . 10i are arranged according to a matrix topology, a data frame transmitted by one of the subscribers 12a, 12b, . . . 12l is distributed on all of the links 14 of the network, which allows the reception of said frame by all of the other subscribers of the network. Thus, each subscriber of the network can communicate with all of the other subscribers of the network. “Matrix topology” in this case refers to the fact that the communication nodes 10a, 10b, . . . 10i are arranged in rows and columns, for example, 3 rows and 3 columns as shown in FIG. 2, each communication node having 4 communication ports connected to communication ports of other communication nodes or to communication ports of subscribers of the network. The invention is not however limited to such a topology or to communication nodes having 4 communication ports and other network topologies can be envisaged.

In a particular example embodiment, subscribers of the set of subscribers are configured for communicating on the network according to a communication protocol compatible with the ARINC 664 part 7 standard. As already indicated, this standard provides virtual links for the exchanges of data frames between the subscribers of the communication network: a subscriber transmits data frames on a virtual link to one or more receiving subscribers and each virtual link is allocated with a maximum bandwidth. A virtual link uses physical links of the communication network and passes through one or more communication nodes. Several virtual links can use a same physical link as long as the total of the maximum bandwidths allocated to these virtual links does not exceed the bandwidth supported by that physical link. In a particular example embodiment, the authorized maximum bandwidth for transmission on the network associated with a subscriber of the network corresponds to the total of the maximum bandwidths allocated to the defined virtual transmission links for that subscriber. Consequently, the condition according to which the total of the authorized maximum bandwidths corresponding to each of the subscribers is less than or equal to said specified bandwidth, for example 100 Mbits/s, is equivalent to a condition according to which the total of the maximum bandwidths allocated to each of the virtual links defined in the network is less than said specified bandwidth. During the design of such a network, it is therefore appropriate to define the different virtual links in compliance with this condition and the different subscribers of the communication network must be configured consequently. In order to do this, the subscribers conventionally comprise virtual link configuration tables. Once the subscribers are thus configured, no configuration of the communication nodes is necessary. This makes it possible to simplify the design the evolution of the communication network in comparison with the networks of the prior art compatible with the ARINC 664 part 7 standard, since it is not necessary to configure paths of the virtual links in switches of the network. Unlike the networks of the prior art, when a subscriber of the network transmits a data frame on a virtual link, that data frame is distributed on all of the physical links 14 of the network. That frame is therefore received by all of the other subscribers of the network. The other subscribers use their configuration tables to determine whether to accept the received frame, for example, only the receiving subscribers of the virtual link in question accept the reception of the data frame. Given that each data frame is distributed on all of the physical links of the network, the network is robust when there is a failure of some of the physical links. In this particular example embodiment, the identifier associated with a data frame can for example correspond to the combination of a virtual link identifier and a sequence number of the frame.

In another example embodiment, the communication network is of the full-duplex Ethernet type. The identifier associated with a data frame can for example correspond to the combination of the source Ethernet address corresponding to the subscriber having transmitted that data frame with a frame number generated by that subscriber, this frame number being for example contained in an IP (Internet Protocol) header field of the frame.

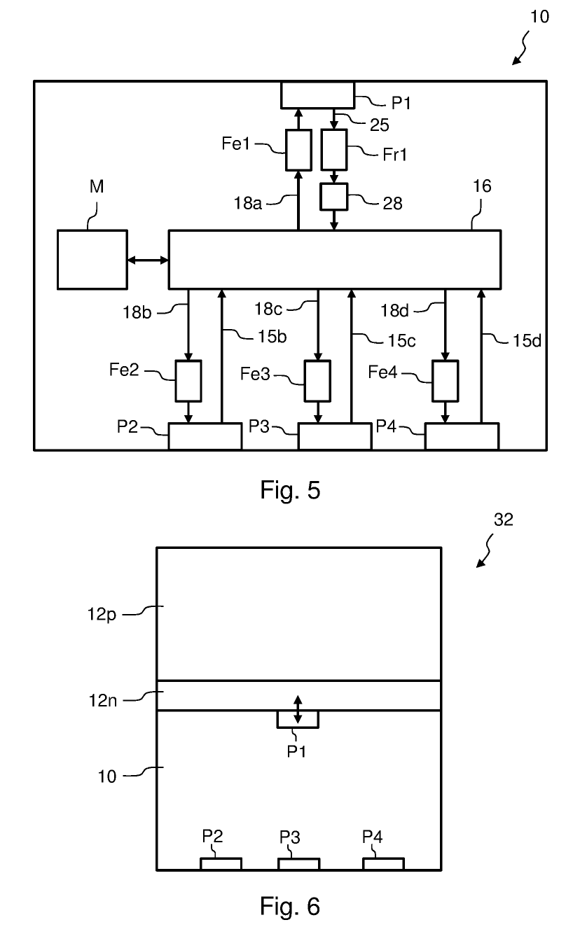

In an example embodiment shown in FIG. 5, the communication node 10 comprises a reception queue associated with at least one of the communication ports, in this case a reception queue Fr1 associated with the communication port P1 and connected to the latter by a link 25. The communication node also comprises a traffic regulator 28 connected on the one hand to that reception queue and on the other hand to the processing unit 16. This traffic regulator can correspond to a software application used by the processing unit 16 or to a separate processing unit. Alternatively, the traffic regulator can be implemented in a hardware manner by an electronic circuit in the communication node. The traffic regulator is configured for reading data in the reception queue and for sending these data to the processing unit, whilst limiting the reading and sending of the data in terms of an authorized maximum bandwidth for that communication port. Thus, when the communication port P1 receives a data frame, it sends the data corresponding to that data frame to the reception queue Fr1 by the link 25. The traffic regulator 28 retrieves the data by reading them from the reception queue Fr1, for example according to a FIFO principle, and it sends them to the processing unit 16. This example embodiment is particularly advantageous when the communication network is of the full-duplex Ethernet type, and the communication port P1 is connected, by a link 14, to a communication port of a subscriber of the communication network. The authorized maximum bandwidth for the communication port P1 is chosen to be equal to the authorized maximum bandwidth for transmission on the network, associated with that subscriber. It is not therefore necessary to configure that authorized maximum bandwidth in the subscriber, the subscriber thus being able to be provided with a standard Ethernet communication port. This example embodiment is duplicated in each one of the communication nodes 10a, 10b, . . . 10i of the network, having a communication port connected to a subscriber 12a, 12b, . . . 12l. During the design or evolution of the network, it is appropriate to define an authorized maximum bandwidth for transmission on the network for each of the subscribers and then to configure the communication nodes connected to these subscribers with the bandwidths defined to be used by their traffic regulators. Although this example embodiment is particularly advantageous in the case of a full-duplex Ethernet network, it can also be used in the abovementioned case of a communication network using a communication protocol compatible with the ARINC 664 part 7 standard. It thus makes it possible to guarantee that, in the case of a malfunction of a subscriber which would cause an exceeding of the authorized maximum bandwidth for that subscriber, the communication node would then limit the data traffic coming from said subscriber and retransmitted on the communication network.

Advantageously, the communication node 10 is integrated in a subscriber 32 of the communication network, as shown in FIG. 6. Thus, in addition to the communication node 10, this subscriber 32 comprises a processing unit 12p and a communication interface unit 12n. The communication node 10 is connected to the communication interface unit by its port P1. The processing unit 12p corresponds for example to an avionic computer of the aircraft and the communication interface 12n corresponds for example to a communication port of said computer. The communication interface unit 12n and the communication port P1 can also correspond to communication software layers of said computer and of the communication node, which makes it possible for example to avoid the setting up of physical data transport layers between the computer and the communication node.

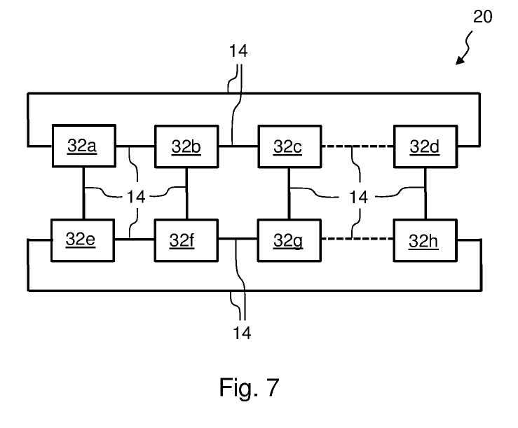

The integration of the communication node 10 in the subscriber 32 makes it possible to simplify the communication network, such that the communication network does not need specific equipment for implementing the functions of a communication node. As shown in FIG. 7, the communication network thus comprises only subscribers 32a, 32b, . . . 32h and a set of links 14 between these subscribers. This allows saving space and weight, which is particularly advantageous in the case of a communication network of an aircraft.

While at least one exemplary embodiment of the present invention has been shown and described, it should be understood that modifications, substitutions and alternatives may be apparent to one of ordinary skill in the art and can be made without departing from the scope of the invention described herein. This application is intended to cover any adaptations or variations of the specific embodiments discussed herein. In addition, in this application, the terms “comprise” or “comprising” do not exclude other elements or steps, the terms “a” or “one” do not exclude a plural number and the term “or” means either or both. Furthermore, characteristics or steps which have been described with reference to one of the above exemplary embodiments may also be used in combination with other characteristics or steps of other exemplary embodiments described above.

What is claimed is:

1. A communication network comprising:
a set of links each supporting a specified bandwidth;
a set of subscribers;
at least one communication node comprising a set of communication ports, these communication ports being connected to links of the set of links, wherein:
each one of the set of subscribers is associated with an authorized maximum bandwidth for transmission on the network, in such a way that a sum of authorized maximum bandwidths corresponding to respective subscriber is less than or equal to said authorized maximum bandwidth associated with respective subscriber,
said at least one communication node comprises a processing unit and a memory and the processing unit is configured for, when a data frame is received on one of the communication ports of the communication node:
checking if the memory contains an identifier associated with the data frame; and
if the memory does not contain the identifier associated with the data frame:
sending that data frame to all of the other communication ports of the communication node and storing the identifier associated with the data frame in the memory.

2. The communication network as claimed in claim 1, wherein links of the set of links are arranged in pairs in order to form a network of a full-duplex type.

3. The communication network as claimed in claim 1, wherein subscribers of the set of subscribers are configured for communicating on the network according to a communication protocol compatible with the ARINC 664 part 7 standard.

4. The communication network as claimed in claim 3, wherein the identifier associated with the data frame corresponds to a virtual link identifier and a sequence number of the frame.

5. The communication network as claimed in claim 1, wherein subscribers of the set of subscribers are configured for communicating on the network according to a communication protocol compatible with the Ethernet standard.

6. The communication network as claimed in claim 5, wherein the identifier associated with the data frame corresponds to an identifier of a corresponding transmitting subscriber and of a frame number generated by that subscriber.

7. The communication network as claimed in claim 1, comprising at least four communication nodes each comprising four communication ports, these communication nodes being arranged according to a matrix topology.

8. The communication network as claimed in claim 1, wherein said at least one communication node is integrated in one of the set of subscribers.

9. A communication node of a communication network, the communication network comprising:
a set of links each supporting a specified bandwidth, and
a set of subscribers, each one of the set of subscribers being associated with an authorized maximum bandwidth for transmission on the network, in such a way that a sum of authorized maximum bandwidths corresponding to respective subscriber is less than or equal to the authorized maximum bandwidth associated with respective subscriber,
the communication node comprising a set of communication ports, these communication ports being connected to links of the network,
wherein the communication node comprises a processing unit and a memory and the processing unit is configured for, when receiving a data frame on one of the communication ports of the communication node:
checking if the memory contains an identifier associated with the data frame;
if the memory does not contain the identifier associated with the data frame:
sending that data frame to all of the other communication ports of the communication node; and
storing, in the memory, the identifier associated with the data frame.

10. The communication node as claimed in claim 9, further comprising a transmission queue associated with a communication port.

11. The communication node as claimed in claim 9, further comprising:
a reception queue associated with a communication port; and
a traffic regulator associated with the communication port, the traffic regulator being configured for reading data in the reception queue and for sending these data to the processing unit, whilst limiting the reading and sending of the data in terms of an authorized maximum bandwidth for the communication port.

12. An aircraft, comprising a communication network as claimed in claim 1.

13. A communication network on board a vehicle, the communication network comprising:
a plurality of communication links;
a plurality of communication nodes; and
a plurality of subscribers, each subscriber being connected to at least one of the plurality of communication nodes, and each subscriber being associated with an authorized maximum bandwidth for transmission on the communication network, such that a sum of authorized maximum bandwidths corresponding to respect subscriber is less than or equal to the authorized maximum bandwidth associated with respective subscriber, wherein
each communication node includes a plurality of communication ports and is configured to:
when a data frame is received on one communication port of respective communication node, check whether the data frame has been transmitted by respective communication node; and
in response to the determination that the data frame has not been transmitted by respective communication node, send the data frame to all the other communication ports of respective communication node.

14. The communication network according to claim 13, wherein at least one of the plurality of communication nodes is integrated in one of the plurality of subscribers.

15. The communication network according to claim 13, wherein
each communication node further includes a memory, and
each communication node is further configured to store an identifier of a data frame in its memory after the data frame has been transmitted by respective communication node.

16. The communication network according to claim 15, wherein each communication node is further configured to check whether its memory contains an identifier of a data frame in determining whether the data frame has been transmitted by respective communication node.

17. The communication network according to claim 13, wherein each communication node further includes:
a reception queue and a traffic regulator associated with a communication port of respective communication node, the traffic regulator being configured to limit reading and sending of data in the reception queue in terms of an authorized maximum bandwidth of the communication port.

18. A communication node of a communication network on board a vehicle, the communication network comprising:
a plurality of communication links;
a plurality of communication nodes; and
a plurality of subscribers, each subscriber being connected to at least one of the plurality of communication nodes, and each subscriber being associated with an authorized maximum bandwidth for transmission on the communication network, such that a sum of authorized maximum bandwidths corresponding to respect subscriber is less than or equal to the authorized maximum bandwidth associated with respective subscriber, wherein
each communication node includes a plurality of communication ports and is configured to:
when a data frame is received on one communication port of respective communication node, check whether the data frame has been transmitted by respective communication node; and
in response to the determination that the data frame has not been transmitted by respective communication node, send the data frame to all the other communication ports of respective communication node.

19. The communication node according to claim 18, further comprising:
a reception queue and a traffic regulator associated with a communication port of the communication node, the traffic regulator being configured to limit reading and sending of data in the reception queue in terms of an authorized maximum bandwidth of the communication port.

20. A subscriber of a communication network on board a vehicle, the communication network comprising:
a plurality of communication links; and
a plurality of communication nodes,
the subscriber of the communication network being connected to the at least one of the plurality of communication nodes, and the subscriber being associated with an authorized maximum bandwidth for transmission on the communication network, such that a sum of authorized maximum bandwidths corresponding to the subscriber is less than or equal to the authorized maximum bandwidth associated with the subscriber, wherein
each communication node includes a plurality of communication ports and is configured to:
when a data frame is received on one communication port of respective communication node, check whether the data frame has been transmitted by respective communication node; and
in response to the determination that the data frame has not been transmitted by respective communication node, send the data frame to all the other communication ports of respective communication node.
